(19) United States
(12) Patent Application Publication
(10) Pub. No.: US 2014/0145047 A1
(43) Pub. Date: May 29, 2014

(54) APPARATUS FOR SUSPENDING A THREE-DIMENSION DISPLAY ARTICLE TO A POLE

(71) Applicant: SMAKDAPP, INC., TRAVERSE CITY, MI (US)

(72) Inventor: Paul J. BRITTEN, Traverse City, MI (US)

(21) Appl. No.: 14/088,770

(22) Filed: Nov. 25, 2013

Related U.S. Application Data
(60) Provisional application No. 61/730,631, filed on Nov. 28, 2012.

(51) Int. Cl. F16M 13/02

(52) U.S. Cl. CPC F16M 13/02
USPC 248/218.4

(57) ABSTRACT

A suspension apparatus for suspending a three-dimensional display article from a pole has at least one of an upper and lower article support member to which an upper or lower perimeter of the display articles attaches. Each support member has at least one strap attached to it at an end of the strap and also attached an opposed end of the strap to a fastening member securable to the pole.

### CROSS-REFERENCE TO RELATED APPLICATIONS

This application claims the benefit of U.S. Provisional Application No. 61/730,631 filed on Nov. 28, 2012. The entire disclosure of the above application is incorporated herein by reference.

### FIELD

The present disclosure relates to an apparatus for suspending a three-dimensional display article to a pole.

### BACKGROUND

This section provides background information related to the present disclosure which is not necessarily prior art.

It is common to suspend three-dimensional display articles, such as a cup-shaped banner, to an outdoor pole. In doing so, wind loading on the display article must be taken into account and the display article suspended in such a manner that allows the display article some freedom of movement due to wind loading. Otherwise, the forces exerted by the wind loading might result in damage to the display article or blow the display article off the pole.

### SUMMARY

This section provides a general summary of the disclosure, and is not a comprehensive disclosure of its full scope or all of its features.

A suspension apparatus for suspending a three-dimensional display article from a pole has at least one of an upper and lower article support member to which an upper or lower perimeter of the display articles attaches. Each support member has at least one strap attached to it at an end of the strap and also attached an opposed end of the strap to a fastening member securable to the pole. In aspect, the suspension apparatus includes an upper article support member to which the upper perimeter of the display article attaches and a lower article support member to which the lower perimeter of the display article attaches. In an aspect, the suspension apparatus includes a plurality of straps attached at ends to the upper article support member and at opposed ends to an upper fastening member securable to the pole. In an aspect, the suspension apparatus includes a plurality of straps attached at ends to the lower article support member and at opposed ends to a lower fastening member securable to the pole.

In an aspect, each article support member includes a radially inwardly extending portion to which the strap attached to that article support member is attached. In an aspect, each article support member has a plurality of radially inwardly extending support portions, one for each strap attached to that article support member. In an aspect, the radially inwardly extending portions of each article support member also extends axially inwardly to a distal end and the ends of the strap attached to each article support member are attached to the distal end of respective radially inwardly extending portions of that article support member.

In an aspect, the straps are elastic.

In an aspect, the fastening members are elastomeric and securable to the pole by friction. In an aspect, the fastening members are hooks.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side cut-away view of the suspension apparatus in accordance with an aspect of the present disclosure suspending a cup-shaped banner from a pole; and

FIG. 2 is a perspective view of the cup-shaped banner of FIG. 1; and

FIG. 3 is a perspective view of the suspensions apparatus of FIG. 1 showing a variation of the article support members of the suspension apparatus.

Corresponding reference numerals indicate corresponding parts throughout the several views of the drawings.

### DETAILED DESCRIPTION

Example embodiments will now be described more fully with reference to the accompanying drawings.

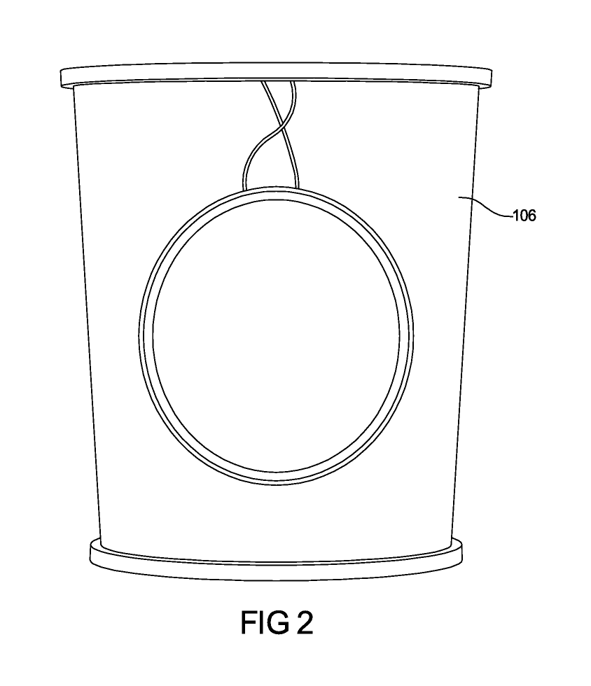

With reference to the drawings, a three-dimensional display article 100 is shown suspended from a pole 102 by a suspension apparatus 104. In the illustrative embodiment shown in the figure, the display article is a cup-shaped banner 106 (as best shown in FIG. 2). It should be understood that the display article 100 could be other than a cup-shaped banner.

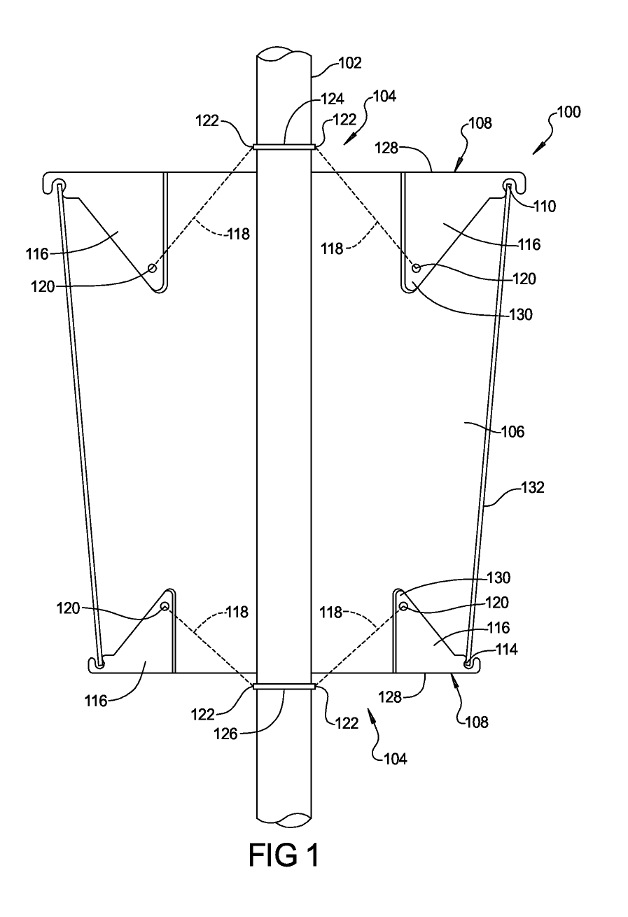

Suspension apparatus 104 includes upper and lower article support members 108 to which upper and lower perimeters 110, 112, respectively, of banner 106 attach. In the embodiment shown in the drawings, article support members have a conventional ring shape but can also have other annular shapes, such as a disk shape, or other geometric shapes, such as triangular, pentagonal, hexagonal, etc. Article support members 108 include a radially inwardly extending portion 116 (which may be a plurality of discrete members) to which a plurality of straps 118 attach. Each strap 118 is attached at an end 120 to one of the article support members 108. Each article support member 108 illustratively has a plurality of straps 118 attached to it, which may be equidistantly spaced around the article support member 108. Straps 118 may be elastic straps and may for example be bungee cords, but can be other types of elastic straps. It should be understood that straps 118 need not be elastic and could for example be a wire cable or a nylon strap. In this regard, as used herein, the term strap is used broadly to include flat and round straps, cords, wire cables, flexible wires, and the like. The radially inwardly extending portion 116 of the top article support member 108 may also extend axially inwardly so that it extends downwardly and the radially inwardly extending portion 116 of the lower article support member 108 may also extend axially inwardly so that it extends upwardly. In the embodiment shown in FIG. 2, each article support member has a proximal end 128 adjacent the respective upper or lower perimeter 110, 112 of banner 106 and a distal end 130 axially inwardly spaced from the proximal end 128 and also radially inwardly spaced from an outer periphery 132 of banner 106. It should be understood that each article support member 108 may have a plurality of radially inwardly extending portions 116 with each radially inwardly extending portion have a different one of straps 118 attached to it. Ends 120 of the straps 118 are illustratively attached to the article support member at the distal ends 130 of straps 118. The straps 118 attached to the upper article support member 108 attach at their other opposed end 122 to an upper fastening member 124 secured to the pole 102 and the straps 118 attached to the lower article support member 108 attach at their ends 122 to a lower fastening member 126 secured to the pole 102. The upper and lower fastening members 124, 126 are securable to the pole 102, such as by fasteners (not shown), such as screws. They may also be securable by to the pole by frictional engagement and have a diameter slightly smaller than a diameter of the pole 102. The fastening members may be elastomeric rings in this regard. The upper and lower fastening members may be hooks that are received in holes (not shown) in pole 102. As shown in FIG. 1, upper and lower fastening members 124, 126 are spaced from each other and upper fastening member 124 is secured to pole 102 above where ends 122 of straps 118 attach to upper article support member 108 and lower fastening member 126 is secured on pole 102 below where ends 122 of straps 118 attach to lower article support member 108.

As best shown in FIG. 1, the straps 118 securing the article support member 108 to the pole 102 are concealed from sight within the interior of the banner 106. Illustratively, the straps 118 are also stretched somewhat between the respective upper and lower article support member 108 and the respective upper and lower fastening members 124, 126 so that they are in tension and pull on the upper and lower article support members 108 toward upper and lower fastening members 124, 126. The display article 100 may be any 3-D shape, such as a cube, cone, cup (such as cup-shaped banner 106 shown in the example embodiment), cylinder, or the like. Since the display article 100 is secured to the pole 102 by the straps 118, this allows the display article to wiggle in the wind.

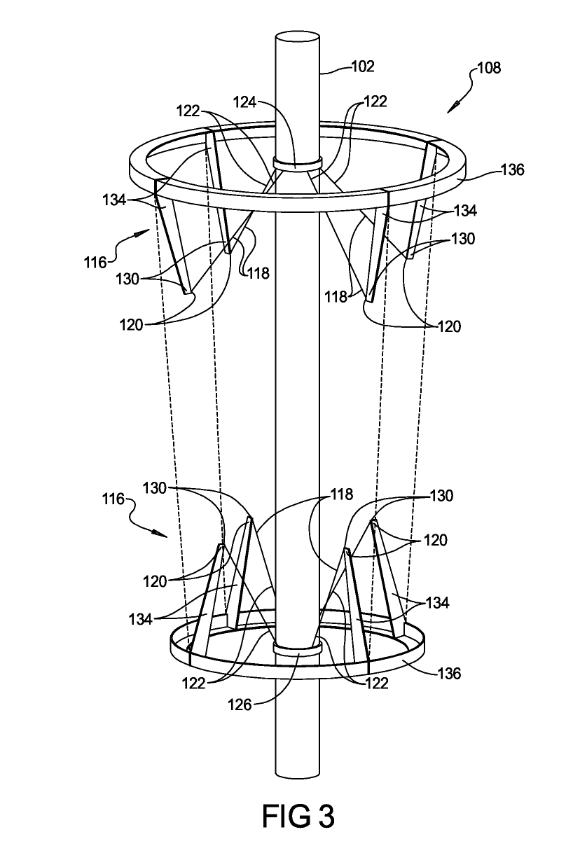

FIG. 3 shows a variation of article support members 108. As shown in FIG. 3, radially inwardly extending portion 116 of article support members 108 comprises a plurality of rigid projections 134 that extend radially and axially inwardly from an outer periphery 136 of article support members 108. It should be understood that radially inwardly extending portions 116 of each article support member 108 may be any type of rigid member, such as a plate, rigid wire, or the like.

While in the embodiments shown in the drawings, both the upper and lower support members have respective radially inwardly extending portions 116 and respective straps 118 attached thereto, it should be understood that one of the upper and lower article support members need be used. It also should be understood that while in the embodiments shown in the drawings, a plurality of straps 118 secured to each of upper and lower article support members 108 are shown, it should be understood that a single strap 118 could be used.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A suspension apparatus for suspending a three-dimensional display article from a pole, comprising:
at least one an article support member to which an upper or lower perimeter of the display article attaches; and
each support member having at least one strap attached to it at an end of the strap with an opposed end of the strap attached to a fastening member that is securable to the pole.

2. The suspension apparatus of claim 1 wherein the at least one article support member includes an upper article support member and a lower article support member, the at least one fastening member including an upper fastening member and a lower fastening member, the at least one strap including a plurality of straps connected at ends to the upper article support member and at opposed ends to the upper fastening member and a plurality of straps connected at ends to the lower article support member and at opposed ends to the lower fastening member.

3. The suspension apparatus of claim 2 wherein each article support member includes radially inwardly extending portions to which the straps attached to that article support member are attached with each radially inwardly extending portion having a respective one of the straps attached to it.

4. The suspension apparatus of claim 3 wherein the radially inwardly extending portions of each article support member also extend axially inwardly to distal ends and the ends of the straps attached to each article support member are attached to the distal ends of the radially inwardly extending portions.

5. The suspension apparatus of claim 4 wherein each radially inwardly extending portion is a rigid projection that extends radially inwardly and axially inwardly.

6. The suspension apparatus of claim 2 wherein the upper and lower fastening members are elastomeric and securable to the pole by friction.

7. The suspension apparatus of claim 2 wherein the upper and lower fastening members are hooks.

8. The suspension apparatus of claim 2 wherein each strap is an elastic strap.

9. The suspension apparatus of claim 2 wherein each article support member is ring shaped.

10. A suspension apparatus for suspending a three-dimensional display article from a pole, comprising:
an upper article support member to which an upper perimeter of the display article attaches and a lower article support member to which a lower perimeter of the display article attaches;
the upper article support member having a plurality of rigid projections that extend radially and axially inwardly from a periphery of the upper article support member, each projection having a distal end and a strap attached to that distal end with an opposed end of the strap attached to an upper fastening member securable to the pole; and
the lower article support member having a plurality of rigid projections that extend radially and axially inwardly from a periphery of the lower article support member, each projection having a distal end and a strap attached to that distal end with an opposed end of the strap attached to a lower fastening member securable to the pole.

11. The suspension apparatus of claim 10 wherein the upper and lower fastening members are elastomeric and securable to the pole by friction.

12. The suspension apparatus of claim 10 wherein the upper and lower fastening members are hooks.

13. The suspension apparatus of claim 10 wherein each strap is an elastic strap.

14. The suspension apparatus of claim 10 wherein the upper and lower article support members are ring shaped.
